(19) United States
(12) Patent Application Publication
(10) Pub. No.: US 2005/0222996 A1
(43) Pub. Date: Oct. 6, 2005

(54) Managing event-condition-action rules in a database system

(75) Inventor: Aravind Yalamanchi, Nashua, NH (US)

Correspondence Address: HICKMAN PALERMO TRUONG & BECKER, LLP, 2055 GATEWAY PLACE, SUITE 550, SAN JOSE, CA, 95110, US

(73) Assignee: ORACLE INTERNATIONAL CORPORATION, REDWOOD SHORES, CA (US)

(21) Appl. No.: 10/815,220

(22) Filed: Mar. 30, 2004

(51) Int. Cl. G06F 7/00

(52) U.S. Cl. 707/4

(57) ABSTRACT

Use of a database-enabled rules engine includes receiving and storing ECA expressions in the database. Such expressions specify (1) an event structure that defines an event that corresponds with the event structure; (2) conditions for evaluation with respect to occurrences of events that correspond with the event structure; and (3) actions for performance in response to events satisfying one or more of the conditions. Such expressions are stored in columns of a database table. Hence, during a database session in which the rules are evaluated with respect to one or more events, an event is detected based on the event's compliance with the specified event structure and the conditions are evaluated by determining whether the event satisfies any of the conditions. If the event satisfies a set of one or more conditions that have a corresponding action, then the corresponding action is performed by the database or the database causes the action to be performed outside of the database.

### CROSS REFERENCE TO RELATED APPLICATIONS

This application is related to U.S. patent application Ser. No. 10/254,383 entitled “Managing Expressions In A Database System,” filed on Sep. 24, 2002 and published as US-2003-0212670-A1; is related to U.S. patent application Ser. No. 10/365,771 entitled “Managing XPATH Expressions In A Database System,” filed on Feb. 12, 2003; and is related to U.S. patent application Ser. No. 10/418,882 entitled “Extensible Rules Engine In A Database Management System,” filed on Apr. 17, 2003 and published as US-2003-0212657-A; all of which are incorporated by reference in their entirety for all purposes as if fully set forth herein.

### FIELD OF THE INVENTION

The present invention relates generally to database systems and, more specifically, to techniques for managing event-condition-action expressions in database systems.

### BACKGROUND OF THE INVENTION

Rules Engines

Rules are typically used in business applications to guide or influence the business behavior in real-time. A majority of these applications need event-centric rules to monitor the creation of new business objects or some state changes in the business processes. An example of an event-centric rule, in the context of the travel business, is as follows: if a party reserves an airline ticket to Orlando and reserves a luxury car, offer a promotional discount to a particular Orlando hotel. Hence, upon the occurrence of the two events, the application would automatically offer the promotion to the party.

In the context of rules engines, rules are broadly divided into two classes: (1) deductive or inference rules; and (2) reactive or Event-Condition-Action (ECA) rules. The deductive rules use forward and backward reasoning to infer or deduce facts from existing knowledge bases. The ECA rules are well suited for event-centric problems, which deal with a state change and how to manage it.

Existing commercial rules engine applications act as repositories for business rules and facilitate the separation of the business logic from the application logic. Rules engines define some rule languages to allow declarative specification of rules and some interfaces to allow applications to interact with the rules engine. However, the types of rules managed by such engines are deductive in nature.

Some forms of ECA rules can be formulated as deductive rules and can be managed by rules engines that are designed for deductive rules. However, due to the differences in workloads between processing the deductive rules and the ECA rules, a rules engine designed for deductive rules is not effective for managing ECA rules, for the following reasons. Most deductive rules engines use variants of RETE indexes to process a set of rules for a set of facts. These indexes are purely memory-based and they do not scale well for large sets of rules defined for large sets of facts. Also, these indexes are not efficient for highly dynamic facts, which are typical of the events specified in the ECA rules. Furthermore, in a multi-tiered environment, the memory-based rules engines reside in the application layer. Hence, if business events for which the rules are defined are in the database layer, these events need to be fetched into the application layer in order to process the corresponding rules, which degrades the performance of such rules engines.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram that illustrates a visual representation of ECA information in a database and interactions between such information, according to an embodiment;

FIG. 2 is a flow diagram that illustrates a method for managing Event-Condition-Action expressions in a database, according to an embodiment; and

FIG. 3 is a block diagram that illustrates a computer system upon which an embodiment of the invention may be implemented.

### DETAILED DESCRIPTION

Techniques are described for managing expressions in a database system. More specifically, techniques are described for managing event-condition-action expressions in a database system, via a database-enabled rules engine.

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

The following are incorporated by reference in their entirety for all purposes as if fully set forth herein: U.S. Pat. No. 6,405,191 entitled “Content Based Publish-And-Subscribe System Integrated in a Relational Database System,” issued on Jun. 11, 2002; and U.S. Pat. No. 6,502,093, entitled “Approach for Publishing Data in a Relational Database System,” issued on Dec. 31, 2002.

### Overview

Use of a database-enabled, or database-centric, rules engine includes receiving and storing ECA expressions in the database. Such expressions specify (1) an event structure that defines an event that corresponds with the event structure; (2) conditions for evaluation in response to and with respect to occurrences of events, e.g., event instances, that correspond with the event structure; and (3) actions for performance in response to events satisfying one or more of the conditions.

Such conditions are stored in columns of a database table, such as EXPRESSION data type columns. Hence, during a rule run-time database session, i.e., a database session in which the rules are evaluated with respect to one or more events, an event is detected when an event occurs that complies with the specified event structure and the conditions are evaluated by determining whether the event satisfies any of the conditions. If the event satisfies a set of one or more conditions that have a corresponding action, then the corresponding action is performed by the database server or the database server causes the action to be performed outside of the database system.

The rules engine described herein departs from the existing rules engines by managing ECA rules in a relational database. Consequently, advantages such as scalability, reliability, and security are easily extended to rules processing, such as the processing of business rules. In addition, the events for which the rules are defined are relational in nature and a subset of the standard structured query language (SQL) can be used to identify the occurrence of interesting events and to evaluate conditions against the event occurrences. Furthermore, the rich SQL language, for example, in combination with XML, can be used to represent complex business rules.

### Storage of Event-Condition-Action Rules in A DataBase

In one aspect, rules are represented as expressions that are stored in a database as a rule set. In the context of ECA rules, rules comprise (1) an event structure that defines events that correspond with the event structure, (2) conditions against which corresponding events are evaluated, and (3) action preferences for performing in response to satisfaction of conditions by events.

With a database-enabled rules engine as described, the SQL query language can be used as the foundation for the rule language. Hence, expressions can be represented as SQL queries. Simple rule conditions are similar to the WHERE clause of a query in which the FROM clause represents the corresponding event structure. For example, if a FlightInfo table stores information about reserved flight information for all the customers of a travel agent, then the following query can identify all the customers with flight reservations to Orlando on United Airlines.

SELECT CustId FROM FlightInfo
WHERE ToCity=‘Orlando’ and Airline=‘United’

The above query identifies all the existing reservations to Orlando on United Airlines, that are stored in the table FlightInfo. However, if there is a requirement to identify only the new reservation as they are made (e.g., in real-time), the above query should be mapped to a rule that can monitor new data (e.g., events). In this case, the FlightInfo table can be configured as the event structure for the rule, or the event structure can be configured to work with transient application data using an object type with a matching structure. The WHERE clause of the above query can be used for the rule condition and the rule action can be some application logic to perform an action when a reservation matches this rule. For example, the action may be to offer a rental car promotion, offer a discount, and the like.

With SQL forming the foundation for the rule language, adding new rules and updating or deleting existing rules in a rule set can be performed using INSERT, UPDATE and DELETE operations on a corresponding rule set table. Furthermore, a simple SELECT operation on the rule set table allows the user to browse the rules in a rule set.

Event Structure

The event structure describes, on an abstract level, the essential factors that unambiguously identify the occurrence of an event of that type. In one embodiment, the event structure is defined with a set of attributes that describe the specific features of an event, such as a business event, and the event structure is represented as an object type in the database. For example, a business event can capture the flight information that is added to a user's itinerary. In the database, the corresponding event structure can be represented as an object type as specified below.

```
CREATE or REPLACE TYPE AddFlight AS OBJECT (
      CustId NUMBER,
      Airline VARCHAR(20),
      FromCity VARCHAR(30),
      ToCity VARCHAR(30),
      Depart DATE,
      Return DATE).
```

In another embodiment, the rules are defined for data that is stored in relational tables in the database. In this scenario, the event structure for the rule set is derived from the structure of the tables that store the data, and an event is identified as a change in the state of the data (e.g., via INSERT or UPDATE operations).

A set of rules defined for a particular application is considered a rule set and the rules that make up the rule set share a common event structure(s) for their conditions. A rule set is captured as a relational table in a database, where a rule belonging to a rule set is a row in the rule set table.

Composite Events

A composite event can be defined in the database as a combination of multiple primitive events. The rules defined for primitive events and composite events have similar operational characteristics in the database. In one embodiment, a composite event structure is represented as an object type with embedded types. Each embedded type in a composite event represents a primitive event. Each primitive event that is associated with a composite event can occur in a process independent of another process in which another associated primitive event occurs.

In an embodiment, the rules defined for composite events are evaluated incrementally as some parts of the event (e.g., one or more primitive events) occur. The results from the incremental evaluation of related primitive events are stored persistently in the database.

Conditions

The rule conditions against which events are evaluated are expressed using the variables defined in the corresponding event structure. For example, simple rule conditions are similar to the WHERE clause of a query in which the FROM clause represents the corresponding event structure. In a typical system based on rules, efficient filtering of a large set of conditions is critical for the scalability of the system. Unlike a typical database design, where a few queries are executed on a large set of rows in a table, a rules-based system may have a large number of conditions with respect to which an event is evaluated. Therefore, unique approaches to storing and manipulating conditions in a database-enabled rules engine are desirable, such as use of an EXPRESSION data type, described hereafter.

Expression Data Type

In an embodiment, the rule condition column of the rule set table is configured with the Expression data type described in U.S. patent application Ser. No. 10/254,383 entitled “Managing Expressions In A Database System” and published as US-2003-0212670-A1, which is incorporated by reference in its entirety for all purposes as if fully set forth herein.

For example, conditions can be stored in a VARCHAR2 or a CLOB column in a database table. Such a column can be structured as a column of EXPRESSION data type by, for example, associating some metadata to the column. Furthermore, the column storing the conditions is associated with the related event structure. A VARCHAR2 or a CLOB column associated with an event structure constitutes an EXPRESSION column. The values stored in an EXPRESSION column are initially expected to adhere to SQL-WHERE clause format. These conditions can refer to all the attributes defined in the corresponding event structure, along with any system variables and user-defined functions that are valid in the user environment.

Conditions for Composite Events

Rules defined for a composite event consisting of two or more primitive events can be mapped to an equivalent join query. For example, assuming the reserved flight information and rental car information of the customers are stored in two tables, Flightlnfo and CarInfo, respectively, a rule with conditions relating to a flight reservation as well as a rental car reservation (in order to offer a promotion at a hotel) can be mapped to an equivalent example SQL query shown below.

SELECT Flt.CustId FROM FlightInfo Flt, CarInfo Car
WHERE Flt.ToCity = ‘Orlando’ and Flt.Airline = ‘United’ and
Flt.CustId = Car.CustId and Car.CarType = ‘Luxury’

### XML-Extended SQL Syntax

The rules, however, may have unique requirements with respect to when the data pertaining to each primitive event is available and the related need for including the time of primitive event creation in the rule definition. Thus, in an embodiment, the WHERE clause of an equivalent join query is broken into separate conditions on the primitive events, with a join condition. These pieces are then used to represent a complex rule condition using some XML tags within a SQL condition. For example, the WHERE clause of the above rule maps to the following rule condition.

```
<condition>
  <and join=“Flt.CustId =Car.CustId”>
  <object name=“Flt”>Airline=‘United’and ToCity=‘Orlando’</object>
  <object name=“Car”>CarType = ‘Luxury’</object>
  </and>
</condition>
```

Hence, each table in the FROM clause of the equivalent query maps to a primitive event and the combination of these primitive events represents the composite event for the rule set. Using this XML-extended SQL syntax, embodiments can be implemented to support temporal, negation, any, and sequencing semantics in the rule conditions, which is not possible with conventional SQL WHERE clause syntax. These semantics are described hereafter.

### Temporal Events

Rules involving temporal events are activated when an event is detected or not detected within a specified timeframe. An example of a rule involving temporal events is as follows: if an order is placed by a Gold customer and the ordered items are shipped within 12 hours of the order placement, then increment quality of service statistics. Such rules can be specified to use the timestamp variable that is implicitly included in each primitive event, such as the SQL date datatype.

An example of a statement that represents the foregoing rule may be formed as follows.

```
ON
    PlaceOrder(OrderId, ItemId, CustType, ..) order,
    ShipOrder(OrderId, TrackingNo, ..) ship
  IF
    <condition>
      <and join=“order.OrderId = ship.OrderId and
            ship.rlm$crttime − order.rlm$crttime <1/2”>
        <object name=“order”>CustType = ‘Gold’</object>
        <object name=“ship”/>
      </and>
      </condition>
  THEN
    IncrementQOSStats(ship.rlm$crttime − order.rlm$crttime)
```

### Negation

Rule conditions using negation can be specified using the XML-extended SQL syntax, where the actions that are associated with conditions using negation constructs are performed when an event is not detected within a specified timeframe. Such rules are often used to raise exceptions in event-based applications. An example of a rule involving negation is as follows: if an order is placed by a Gold customer and the ordered items are not shipped within 24 hours of the order placement, then notify customer service.

An example of a statement that represents the foregoing rule may be formed as follows.

```
ON
  PlaceOrder(OrderId, ItemId, CustType, ..) order,
  ShipOrder(OrderId, TrackingNo, ..) ship
IF
  <condition>
    <and join=“order.OrderId = ship.Orderld”>
      <object name=“order”>CustType =‘Gold’</object>
    <not by=“sysdate+1”>
      <object name=“ship”/>
    </not>
    </and>
  </condition>
THEN
  AlertRepresentative(OrderId, ‘123’, ‘Delayed Order’)
```

The “not” element in the foregoing condition is activated only when the other primitive event(s) (e.g., order by Gold customer) is detected. If the object within the “not” element is detected within the specified timeframe, then the action is not executed.

### Any n

Rule conditions using “any n” can be specified using the XML-extended SQL syntax, where the actions that are associated with conditions using such constructs are performed when any n events of the specified events are detected. An example of a rule involving “any n” is as follows: if a customer adds two of the following items to a shopping cart, then suggest a tripod to the customer: a camcorder lens worth more than $100, a lens filter, and an IR light.

An example of a statement that represents the foregoing rule may be formed as follows.

```
ON
  AddItem (ItemId, Accessory, Price, ..) Item1,
  AddItem (ItemId, Accessory, Price, ..) Item2,
  AddItem (ItemId, Accessory, Price, ..) Item3
IF
  <condition>
    <any count=2>
      <object name=“Item 1”>
            Accessory = ‘Lens’ and Price> 100 </object>
      <object name=“Item2”> Accessory = ‘Lens Filter’</object>
      <object name=“Item3”> Accessory = ‘IR Light’</object>
    </any>
  </condition>
THEN
    SuggestItem(‘Tripod’)
```

### Sequencing

Rule conditions having sequencing requirements can be specified using the XML-extended SQL syntax, where the actions that are associated with conditions using such constructs are performed when the specified events are detected in a specified order, or sequence. An example of a rule involving sequencing is as follows: if a customer adds the following items to a shopping cart in the specified order, then suggest a tripod to the customer: a camcorder lens worth more than $100, a lens filter, and an IR light.

An example of a statement that represents the foregoing rule may be formed as follows.

```
ON
  AddItem (ItemId, Accessory, Price, ..) Item1,
  AddItem (ItemId, Accessory, Price, ..) Item2,
  AddItem (ItemId, Accessory, Price, ..) Item3
IF
  <condition>
    <and sequence=“yes”>
      <object name=“Item1”>
            Accessory =‘Lens’ and Price > 100 </object>
      <object name=“Item2”> Accessory = ‘Lens Filter’</object>
      <object name=“Item3”> Accessory = ‘IR Light’</object>
    </any>
  </condition>
THEN
    SuggestItem(‘Tripod’)
```

Actions

The action associated with an ECA rule could be any operation that can be performed or initiated by a database server. For example, this includes sending an e-mail, scheduling a job for a later execution, modifying data stored in other relational tables, as well as generation of a new business event. Each rule definition includes a set of action preferences that are used to determine and perform the appropriate action. For example, the action preferences could be a set of scalar values (e.g., email-address) that will be passed to a fixed function that carries the action, or a set of SQL or PL/SQL commands (e.g., an INSERT statement) that is executed when the rule condition is satisfied (e.g., evaluates to true). The exact list of action preferences for a rule set are specified at the time of rule set creation.

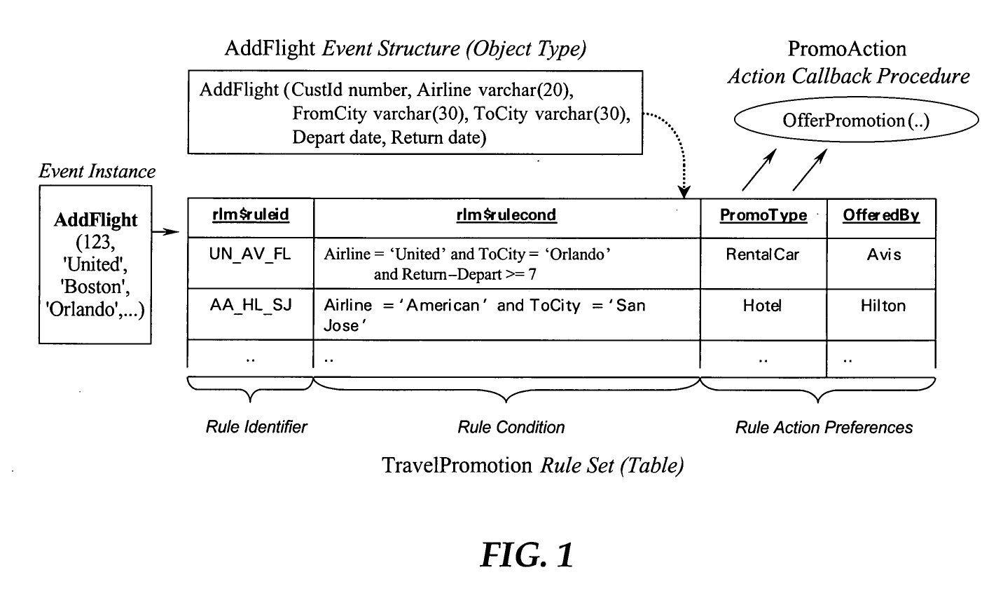

FIG. 1 is a diagram that illustrates a visual representation of ECA information in a database and interactions between such information, according to an embodiment. The functionality of the database-enabled rules engine described herein is centered around the concept of a rule set, which is captured in a relational database table that acts as a repository for rule definitions.

FIG. 1 depicts an AddFlight event structure as an object type that defines an event instance that corresponds to the AddFlight event structure. As discussed, a rule set, which in an embodiment is represented as a set of SQL expressions, is stored in a database table, depicted as the TravelPromotion rule set table of FIG. 1. An ECA rule maps to a row in a rule set table. The table in which the rule set is stored has a rule identifier column, a rule condition column, and rule action preferences columns. As is depicted with the dashed line between the event structure and the rule condition column, the event structure is associated with the rule condition column of the rule set table, in that the rule conditions are specified using variables that are declared in the event structure. In other words, the event structure can be considered metadata for the rule condition column. Furthermore, the rule conditions are derived from attributes of the event structure to which the conditions apply.

FIG. 1 further depicts an event instance, AddFlight, that corresponds with the AddFlight event structure, being added to the database. The event instance has values for the attributes that are defined in the corresponding event structure. The event instance may be created, for example, in response to a business event, with the relevant event information instantiated as an object of the event structure object type. In response to the arrival of the event instance in the database, the rule conditions in the TravelPromotion rule set table are evaluated with respect to the attribute values contained in the event instance object to determine whether any of the conditions are satisfied.

If any conditions that have a corresponding actions in the rule action preferences column are satisfied by the event instance, then an action callback procedure, PromoAction, is executed to perform an action procedure, OfferPromotion, with appropriate values from the rule action preferences columns passed to the action procedure as arguments. An example of a statement that represents the foregoing rule may be formed as follows.

```
PROCEDURE PromoAction (
  rlm$event AddFlight,
  rlm$rule TravelPromotion%ROWTYPE) is
BEGIN
  -- OfferPromotion is a PL/SQL procedure that performs
  -- the appropriate action --
    OfferPromotion (rlm$event.CustId,
            rlm$rule.PromoType,
            rlm$rule.OfferedBy);
END.
```

The event structure, the rule set table and the action callback procedure are typically all created as part of a rule set creation process.

Evaluation of Rule Sets

Once the rules are populated in a rule set, the rules can be evaluated for one or more events. A rule run-time session can be defined as a database session, from database connect to disconnect, in which one or more events are processed. In addition to the session oriented rule processing, immediate execution of actions for satisfied rules can be implemented using a callback mechanism. For example, the callback mechanism may be implemented as a PL/SQL procedure that is invoked for each satisfied condition. The rule action can be performed by this callback procedure using the action preferences associated with the condition and the event that satisfied the condition. In an embodiment, conflict resolution criteria are used to resolve conflicts among multiple conditions that are satisfied by an event, and are specified declaratively at the time of rule set creation through a rule set ordering property, described hereafter.

Testing every rule condition against every event occurrence is typically a linear time solution. When a large rule set is defined, this approach is not scalable for a high volume of data items. Processes used to evaluate rule sets, i.e., evaluate one or more conditions with respect to one or more event occurrences, may vary from implementation to implementation. One example of a process that may be used to evaluate conditions from a large rule set with respect to event occurrences is described in U.S. patent application Ser. No. 10/254,383 entitled “Managing Expressions In A Database System” and published as US-2003-0212670-A1.

The referenced process uses an indexing mechanism to evaluate a large set of conditions efficiently and, consequently, to quicken the evaluation of the rule set for a given one or more events. This index can be defined on a column of EXPRESSION data type, thus a query optimizer can determine the use of the index for the evaluation of a rule set, based on computational costs associated with usage of the index. In an implementation, persistent database objects are created to maintain the index for a rule set, where pre-processing the rule set at the time of index creation populates these database objects. Additionally, the information stored in these objects is maintained to reflect any changes to the rule set using DML operations on the table(s) storing the rules.

According to an embodiment, an Expression Filter is a set of PL/SQL packages and APIs used to manage rules, and to filter the conditions for a given event by matching criteria expressed in conditions with the given event, using SQL or some other query language query. The Expression Filter comprises two components: an EVALUATE operator and an Expression Filter Index type, which are described in US-2003-0212670-A1.

The Expression Filter index type can be used to create an index on any set of conditions stored in a database column of type VARCHAR2, CLOB or BFILE. However, use of another index type other than the foregoing, which may be used on conditions stored as data types, is contemplated and therefore within the scope of embodiments of the invention. The EVALUATE operator can be used to process the conditions stored in an EXPRESSION column. This operator can be used in the WHERE clause of a standard SQL statement to filter the conditions for events. The EVALUATE operator accepts the name of the column storing the conditions and a given data item, e.g., an event, as arguments and the EVALUATE operator internally uses the expression set metadata to evaluate expressions for data items passed in.

The query on the table in which conditions are stored can be extended to include multi-table joins and any other database query operations using GROUP BY clause, ORDER BY clause, HAVING clause, etc. In addition, filtering a set of conditions for a batch of events by joining the table in which conditions are stored with the table storing the event data being processed is contemplated.

Furthermore, since rule sets and the index structure objects, if applicable, are persistently stored in the database, memory constraints associated with the size of rule sets that are encountered in approaches that use main memory extensively, are not applicable to the present embodiments. By contrast, operations according to the present embodiments can store the necessary database blocks into a database buffer cache as they are needed.

Database View

Within a rule session, the list of events processed and the list of matching conditions, along with associated action preferences, are accessible through a database view called the rule set results view. In an embodiment, the rule set results view is created at the time of rule set creation and allows for concurrent rule sessions to display the appropriate results for each respective session using the same view name.

The capability to present the rule session results in a view allows users to perform additional operations on the results, as a set, and thus identify a subset of the conditions for action execution. For example, if the events processed in a rule session match three different conditions that suggest 10%, 15%, and 20% discounts as respective action preferences, then a query on the rule set results view can identify the condition and event combination that offers the maximum discount. Hence, the rule set results view can be used to support complex conflict resolution criteria among matching conditions.

The results from the rule set results view can further be used to schedule actions outside the database. For example, events can be injected into the rules engine processing from an application server, the rule set results view can be queried to find all the matching conditions, and the results from this view can be used to schedule some action in the application server.

Rule Set Properties

While managing and processing events added to the system, the database-enabled rules engine enforces various event management policies that vary from rule set to rule set. Such policies can be declaratively set at the time of rule set creation, and are applicable to all the rules in a given rule set.

Consumption of Events

One event management policy that can be set is referred to as consumption. Use of a consumption policy allows specification of whether an event can be used for exclusive satisfaction of a single condition or for shared satisfaction of multiple conditions. If for only a single condition, then the event is “consumed” by a given condition that the event satisfies and, consequently, the associated event information is deleted from the database after such a determination is made. If, on the other hand, an event is not specified to be consumed upon satisfaction of a condition, then the event information is not deleted from the database and evaluation of conditions with respect to the event can continue.

Duration of Events

One event management policy that can be set is referred to as duration. Use of a duration policy allows specification of the lifetime, or duration of, unconsumed primitive events. For example, a given primitive event may be specified to last until the end of the transaction in which the event occurred, or until the end of the database session in which the event occurred, before expiring. At expiration, the event information is deleted from the database and, therefore, no longer evaluated against relevant conditions. For another example, a given primitive event may be specified to last for a particular period of time.

Ordering of Rule Evaluation

One event management policy that can be set is referred to as ordering. Use of an ordering policy allows specification of an order in which rules (and, hence, the conditions corresponding to a given rule) are evaluated against primitive events that make up a composite event. Because a given primitive event could be constituent to more than one composite event that could satisfy more than one rule, an ordering policy may be used to specify a conflict resolution policy to avoid conflicts between actions associated with satisfied conditions of respective rules. In an embodiment, a SQL ORDER BY clause based on the event attributes and the action preferences is used to specify an ordering policy. In addition, an ordering policy can be used in conjunction with a consumption policy to avoid the satisfaction of multiple conditions with contradicting actions, because an event that satisfies a condition is deleted according to the consumption policy before it is evaluated, according to the ordering policy, against any more conditions that could potentially be satisfied by the event.

### Managing Expressions in A Database System

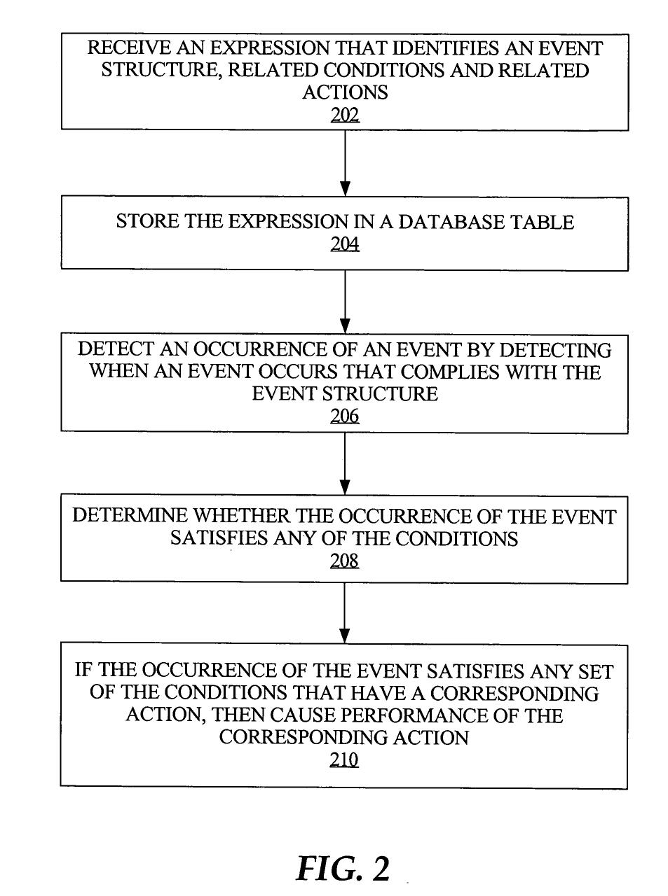

With reference to the foregoing description, FIG. 2 is a flow diagram that illustrates a method for managing Event-Condition-Action expressions in a database, according to an embodiment. The method of FIG. 2 is performed, for example, by one or more database servers that each govern and facilitate access to a particular database, processing requests by clients to access the database and manipulate data from the database.

At block 202, an expression is received that identifies an event structure, one or more related conditions and one or more related actions, each of which is previously described herein. For example, rules may be expressed in the following ECA (Event-Condition-Action) notation, or may be expressed in any other notation, such as in a standard SQL statement.

| | |
|---|---|
| ON | <event structure> |
| IF | <condition> |
| THEN | <action> |

At block 204, the expression is stored in one or more tables within the database, as illustrated in the example of FIG. 1. Hence, during a database session, referred to previously as a rule run-time database session, an occurrence of an event is detected when an event occurs that complies with the event structure, block 206. For example, when the event instance depicted in FIG. 1 is added to the database, the rules engine detects that this event instance corresponds to the particular event structure based on the attributes contained in the event instance. In scenarios in which the event structure is derived from the structure of the tables that store event data, then an event occurrence is detected as a change in the state of the data (e.g., via INSERT or UPDATE statements).

Further during the database session, at block 208, it is determined whether the event occurrence that was detected at block 206 satisfies any of the conditions that were specified in the expression that was stored in the database at block 204. Because the rules engine is already aware of the event structure to which the event occurrence corresponds, and the event structure is associated with the rule condition column, the rules engine can determine which conditions are to be evaluated with respect to the event occurrence.

At block 210, if the event occurrence satisfies any set of one or more rule conditions that have a corresponding action(s), then performance of the corresponding action(s) is caused. The action may be performed, or executed, solely within the database, or may be caused to execute outside of the database, such as by an application server. For example, execution of the action is triggered via an action callback procedure, as previously described.

Blocks 206-210 can be repeated, to process as many event occurrences as desired in a given database session. Multiple event occurrences may be grouped and processed in batch during a single session, or multiple event occurrences may be processed independently in separate sessions as the event occurrences are added to the database.

Blocks 206 and 208 can be repeated for each primitive event occurrence associated with a composite event structure, with results of each primitive event persistently stored in the database at least until all of the other sibling primitive events are processed or until the primitive event expires according to a rule set property, such as a duration policy. In a composite event scenario, once blocks 206 and 208 are completed for each primitive event associated with a composite event structure, then block 210 may be performed if applicable.

Because event-related data and rules on such data reside in the same repository, the techniques described herein provide for use of a database-enabled rules engine that processes rules on relational data without fetching the data into a middleware application that is configured in a computing layer between a client and the database. Hence, event-condition-action processing is more efficient than with middleware rules engines. Furthermore, because the database-enabled rules engine supports composite events and the persistent storage of incremental evaluation of conditions with respect to primitive events that make up a composite event, there is no restriction on the size of rule sets or the number of events that can be processed. Still further, unlike the memory-based middleware rules engines that require initialization and activation each time a rule set is loaded into memory, the rule sets used by the database-enabled rules engine are always active as long as the database is active, and ready to accept new rules and events.

### Hardware Overview

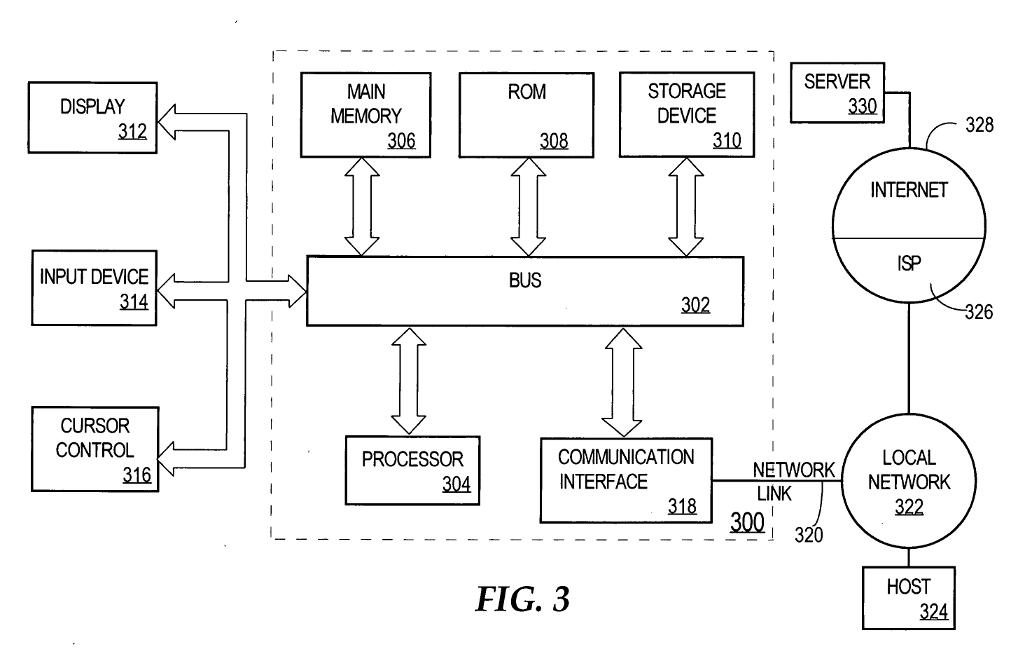

FIG. 3 is a block diagram that illustrates a computer system 300 upon which an embodiment of the invention may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk, optical disk, or magneto-optical disk, is provided and coupled to bus 302 for storing information and instructions.

Computer system 300 may be coupled via bus 302 to a display 312, such as a cathode ray tube (CRT) or a liquid crystal display (LCD), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for implementing the techniques described herein. According to one embodiment of the invention, those techniques are performed by computer system 300 in response to processor 304 executing one or more sequences of one or more instructions contained in main memory 306. Such instructions may be read into main memory 306 from another computer-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 304 for execution. Such a medium may take many forms, including but not limited to, non-volatile media, volatile media, and transmission media. Non-volatile media includes, for example, optical, magnetic, or magneto-optical disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution. In this manner, computer system 300 may obtain application code in the form of a carrier wave.

### Extensions and Alternatives

Alternative embodiments of the invention are described throughout the foregoing description, and in locations that best facilitate understanding the context of the embodiments. Furthermore, the invention has been described with reference to specific embodiments thereof. It will, however, be evident that various modifications and changes may be made thereto without departing from the broader spirit and scope of the invention. For example, implementations were presented in which SQL is used; however, the techniques described herein are not limited to use with SQL, for other data query languages may be applicable. Therefore, the specification and drawings are, accordingly, to be regarded in an illustrative rather than a restrictive sense.

In addition, in this description certain process steps are set forth in a particular order, and alphabetic and alphanumeric labels may be used to identify certain steps. Unless specifically stated in the description, embodiments of the invention are not necessarily limited to any particular order of carrying out such steps. In particular, the labels are used merely for convenient identification of steps, and are not intended to specify or require a particular order of carrying out such steps.

1. A method for managing expressions in a database system, the method comprising the computer-implemented steps of:
receiving an expression that identifies an event structure, one or more related conditions and one or more related actions, wherein said event structure defines an event that corresponds with said event structure;
storing said expression in a table within said database;
during a database session,
detecting an occurrence of said event by detecting when an event occurs that complies with said event structure, and
determining whether said occurrence of said event satisfies any of said conditions; and
if said occurrence of said event satisfies any set of one or more conditions, of said conditions, that is associated with one or more corresponding actions, then causing performance of said one or more corresponding actions.

2. The method of claim 1, wherein receiving an expression comprises receiving an expression that identifies said event structure defined with a set of attributes that describe features of a corresponding event, and wherein said event structure is represented as an object type in said database.

3. The method of claim 1, wherein receiving an expression comprises receiving an expression that identifies said event structure as a composite event structure having two or more primitive events that are each represented, in said database, as an object type embedded in said composite event structure.

4. The method of claim 3,
wherein detecting comprises detecting an occurrence of a first primitive event of said primitive events by detecting when an event occurs that complies with a first primitive event structure of said composite event structure;
wherein determining comprises determining whether said occurrence of said first primitive event satisfies any of said conditions;
the method further comprising the computer-implemented steps of
persistently storing results of said determining in said database,
detecting an occurrence of a second primitive event of said primitive events by detecting when an event occurs that complies with a second primitive event structure of said composite event structure,
determining whether said occurrence of said second primitive event satisfies any of said conditions,
determining whether any of said conditions are satisfied by both said occurrence of said first primitive event and said occurrence of said second primitive event, and
wherein causing performance comprises, if said occurrence of said first primitive event and said occurrence of said second primitive event satisfy any of said set of one or more conditions that have one or more corresponding actions, then performing said one or more corresponding actions.

5. The method of claim 3, further comprising the computer-implemented steps of:
receiving information that specifies a period for which an occurrence of a first primitive event of said two or more primitive events is valid before an occurrence of a second primitive event of said two or more primitive events occurs; and
wherein determining comprises determining whether said occurrence of said first primitive event and said occurrence of said second primitive event satisfy any of said conditions in accordance with said information.

6. The method of claim 3, further comprising the computer-implemented steps of:
receiving information that specifies an order in which to evaluate said conditions with respect to said primitive events; and
wherein determining comprises determining, in said order according to said information, whether said conditions are satisfied by said primitive events.

7. The method of claim 1, wherein receiving an expression comprises receiving an expression that identifies an event structure derived from structure of tables, in said database, that store data that represent event occurrences.

8. The method of claim 7, wherein detecting an occurrence of said event comprises detecting that said data is changed.

9. The method of claim 1, wherein storing said expression in columns of a table comprises storing one or more conditions as an EXPRESSION data type in an EXPRESSION column of said table.

10. The method of claim 1, wherein receiving an expression comprises receiving an expression that identifies a condition that is represented as a SQL query on said database.

11. The method of claim 1, further comprising the computer-implemented step of:
receiving a modification, in the form of a SQL operation, to said one or more conditions of said expression.

12. The method of claim 1, further comprising the computer-implemented step of:
during a database session, providing access to a database view that comprises
a list of event occurrences that have been determined to satisfy any of said conditions,
a list of conditions that have been satisfied by event occurrences in said list of event occurrences, and
a list of actions that correspond with conditions in said list of conditions.

13. The method of claim 12, further comprising the computer-implemented step of:
in response to a request from a user of said database system, performing an operation on said view.

14. The method of claim 13, wherein performing an operation comprises performing an operation to resolve a conflict among two or more conditions that have been satisfied by event occurrences in said list of event occurrences.

15. The method of claim 13, wherein performing an operation comprises performing an operation that includes scheduling an action for performance outside of said database system.

16. The method of claim 1, further comprising the computer-implemented steps of:
receiving information that specifies that the step of determining is to stop when determining that said occurrence of said event satisfies said set of one or more conditions; and
stopping determining whether said occurrence of said event satisfies any of said conditions when determining that said occurrence of said event satisfies said set of one or more conditions.

17. The method of claim 1,
wherein receiving an expression comprises receiving an expression that identifies a temporal condition;
wherein said temporal condition specifies that an associated action of the one or more actions is to be performed if a second condition from said set of conditions is satisfied by an occurrence of an event, within a particular time after a first condition from set of conditions is satisfied by an occurrence of an event; and
wherein determining comprises determining whether occurrences of events satisfy said first and second conditions in accordance with said temporal condition.

18. The method of claim 1,
wherein receiving an expression comprises receiving an expression that identifies a negation condition;
wherein said negation condition specifies that an associated action of the one or more actions is to be performed if a second condition from said set of conditions is not satisfied by an occurrence of an event within a particular time after a first condition from set of conditions is satisfied by an occurrence of an event; and
wherein determining comprises determining whether occurrences of events satisfy said first and second conditions in accordance with said negation condition.

19. The method of claim 1,
wherein receiving an expression comprises receiving an expression that identifies a group of conditions that, when a particular number of conditions from said group of conditions is satisfied by one or more occurrences of events, triggers performance of said one or more corresponding actions;
wherein said particular number is less than a number of conditions in said group of conditions; and
wherein determining comprises determining whether one or more occurrences of events satisfy said particular number of conditions from said group of conditions.

20. The method of claim 1,
wherein receiving an expression comprises receiving an expression that identifies a group of sequenced conditions;
wherein said group of sequenced conditions specifies that an associated action of the one or more actions is to be performed if said conditions from said group of sequenced conditions are satisfied in a particular sequence by one or more occurrences of events; and
wherein determining comprises determining whether one or more occurrences of events satisfy said conditions from said group of sequenced conditions in said particular sequence.

21. A computer-readable medium carrying one or more sequences of instructions which, when executed by one or more processors, causes the one or more processors to perform the method recited in claim 1.

22. A computer-readable medium carrying one or more sequences of instructions which, when executed by one or more processors, causes the one or more processors to perform the method recited in claim 2.

23. A computer-readable medium carrying one or more sequences of instructions which, when executed by one or more processors, causes the one or more processors to perform the method recited in claim 3.

24. A computer-readable medium carrying one or more sequences of instructions which, when executed by one or more processors, causes the one or more processors to perform the method recited in claim 4.

25. A computer-readable medium carrying one or more sequences of instructions which, when executed by one or more processors, causes the one or more processors to perform the method recited in claim 5.

26. A computer-readable medium carrying one or more sequences of instructions which, when executed by one or more processors, causes the one or more processors to perform the method recited in claim 6.

27. A computer-readable medium carrying one or more sequences of instructions which, when executed by one or more processors, causes the one or more processors to perform the method recited in claim 7.

28. A computer-readable medium carrying one or more sequences of instructions which, when executed by one or more processors, causes the one or more processors to perform the method recited in claim 8.

29. A computer-readable medium carrying one or more sequences of instructions which, when executed by one or more processors, causes the one or more processors to perform the method recited in claim 9.

30. A computer-readable medium carrying one or more sequences of instructions which, when executed by one or more processors, causes the one or more processors to perform the method recited in claim 10.

31. A computer-readable medium carrying one or more sequences of instructions which, when executed by one or more processors, causes the one or more processors to perform the method recited in claim 11.

32. A computer-readable medium carrying one or more sequences of instructions which, when executed by one or more processors, causes the one or more processors to perform the method recited in claim 12.

33. A computer-readable medium carrying one or more sequences of instructions which, when executed by one or more processors, causes the one or more processors to perform the method recited in claim 13.

34. A computer-readable medium carrying one or more sequences of instructions which, when executed by one or more processors, causes the one or more processors to perform the method recited in claim 14.

35. A computer-readable medium carrying one or more sequences of instructions which, when executed by one or more processors, causes the one or more processors to perform the method recited in claim 15.

36. A computer-readable medium carrying one or more sequences of instructions which, when executed by one or more processors, causes the one or more processors to perform the method recited in claim 16.

37. A computer-readable medium carrying one or more sequences of instructions which, when executed by one or more processors, causes the one or more processors to perform the method recited in claim 17.

38. A computer-readable medium carrying one or more sequences of instructions which, when executed by one or more processors, causes the one or more processors to perform the method recited in claim 18.

39. A computer-readable medium carrying one or more sequences of instructions which, when executed by one or more processors, causes the one or more processors to perform the method recited in claim 19.

40. A computer-readable medium carrying one or more sequences of instructions which, when executed by one or more processors, causes the one or more processors to perform the method recited in claim 20.

41. A system comprising:
means for receiving an expression that identifies an event structure, one or more related conditions and one or more related actions, wherein said event structure defines an event that corresponds with said event structure;
means for storing said expression in a table within said database;
means for detecting, during a database session, an occurrence of said event by detecting when an event occurs that complies with said event structure, and
means for determining, during said database session, whether said occurrence of said event satisfies any of said conditions; and
means for causing performance of said one or more corresponding actions if said occurrence of said event satisfies any set of one or more conditions, of said conditions, that is associated with one or more corresponding actions.
